(19) United States
(12) Patent Application Publication
(10) Pub. No.: US 2023/0078515 A1
(43) Pub. Date: Mar. 16, 2023

(54) MOBILE DEVICE SLEEVE

(71) Applicant: Omar Alvarez, N. Ft Myers, FL (US)

(72) Inventor: Omar Alvarez, N. Ft Myers, FL (US)

(21) Appl. No.: 17/477,142

(22) Filed: Sep. 16, 2021

(51) Int. Cl. H04B 1/3883; F16M 13/02

(52) U.S. Cl. CPC H04B 1/3883; F16M 13/02

(57) ABSTRACT

A mobile device sleeve removably connected to a mobile device, the mobile device sleeve including a main body to receive an end of the mobile device therein, and a connector receiving channel disposed on at least a portion of the main body to receive a connector of a charging cord therein, such that the connector receiving channel prevents the connector from detaching from the mobile device while the main body is connected to the mobile device and the connector is connected to the mobile device.

### BACKGROUND

### 1. Field

The present general inventive concept relates generally to a mobile device accessory, and particularly, to a mobile device sleeve.

### 2. Description of the Related Art

Modern cell phones and/or other mobile electronic devices are a staple of everyday life. In general, mobile devices have a limited power lifespan in exchange for portability. Typically, mobile devices rely on a battery which can be constantly discharging. Thus, these mobile devices are dependent on being periodically charged to allow users to benefit from their vast functionalities.

However, many people will connect their mobile device to a charger using a charging cord only to find the mobile has not been charged due to the charging cord experiencing a disconnect. As such, the battery within the mobile device becomes fully discharged, which prevents a user from accessing the mobile device. The lack of access to the mobile device can be both frustrating and/or dangerous in case of an emergency.

Therefore, there is a need for a mobile device sleeve to facilitate charging and prevent the charging cord from disconnecting.

### SUMMARY

The present general inventive concept provides a mobile device sleeve.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a mobile device sleeve removably connected to a mobile device, the mobile device sleeve including a main body to receive an end of the mobile device therein, and a connector receiving channel disposed on at least a portion of the main body to receive a connector of a charging cord therein, such that the connector receiving channel prevents the connector from detaching from the mobile device while the main body is connected to the mobile device and the connector is connected to the mobile device.

The main body may include a covering surface, and a base disposed within at least a portion of an inner diameter of the covering surface to prevent the mobile device from passing entirely through a space between the covering surface.

The connector receiving channel may at least partially deform in response to receiving the connector therein.

The connector receiving channel may include an adhesive disposed on an inner surface of the connector receiving channel to resist movement of the connector therein.

The mobile device sleeve may further include a plurality of grooves disposed on at least a portion of the main body to facilitate gripping thereof.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a mobile device sleeve, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mobile Device Sleeve 100
Main Body 110
Covering Surface 111
Base 112
Connector Receiving Channel 120
Grooves 130

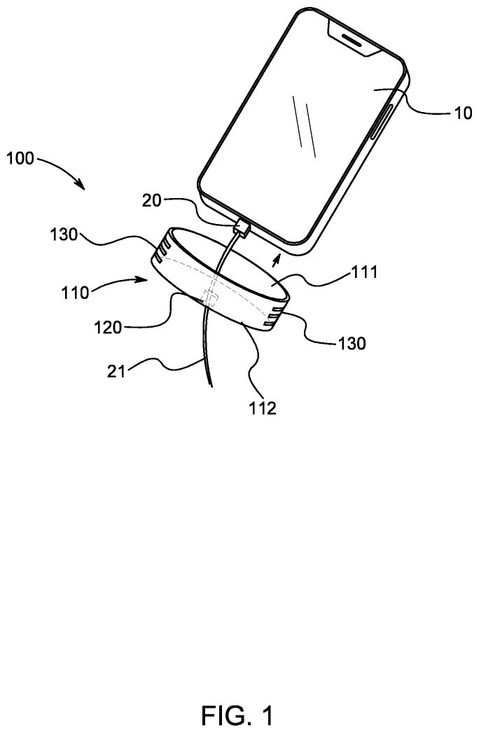

FIG. 1 illustrates a side perspective view of a mobile device sleeve 100, according to an exemplary embodiment of the present general inventive concept.

The mobile device sleeve 100 may be constructed from at least one of rubber, metal, plastic, wood, and glass, etc., but is not limited thereto.

The mobile device sleeve 100 may include a main body 110, a connector receiving channel 120, and a plurality of grooves 130, but is not limited thereto.

Referring to FIG. 1, the main body 110 is illustrated to have a cylindrical shape. However, the main body 110 may be rectangular, circular, conical, triangular, pentagonal, hexagonal, heptagonal, octagonal, or any other shape known to one of ordinary skill in the art, but is not limited thereto.

The main body 110 may be removably connected to at least a portion of a mobile device 10. Moreover, the main body 110 may receive the mobile device 10 therein, such that the main body 110 may at least partially cover an end and/or an edge of the mobile device 10. In other words, only the end and/or the edge of the mobile device 10 may be covered and a majority of the mobile device 10 may be exposed. Additionally, the main body 110 may at least partially deform (i.e. bend, stretch) in response to receiving the mobile device 10 therein. In other words, the main body 110 may be elastic to snugly fit the mobile device 10. Alternatively, the main body 110 may be a fixed size corresponding to a size of the end and/or the edge of the mobile device 10, such that a size of the main body 110 may be based on the size of the mobile device 10. As such, the main body 110 may have various sizes based on the size of the mobile device 10.

The main body 110 may include a covering surface 111 and a base 112, but is not limited thereto.

The covering surface 111 may be circumferentially disposed around at least a portion of a perimeter of the base 112. In other words, the base 112 may be disposed within at least a portion of an inner diameter of the covering surface 111. The covering surface 111 may surround a perimeter of the end and/or the edge of the mobile device 10 while the main body 110 is connected to the mobile device 10.

The base 112 may hold the mobile device 10 within the covering surface 111. More specifically, the base 112 may prevent the mobile device 10 from passing entirely through a space between the covering surface 111.

The connector receiving channel 120 may include an adhesive (e.g., tape, glue), but is not limited thereto.

The connector receiving channel 120 may be perpendicularly disposed away from a center of the base 112 with respect to a direction. The connector receiving channel 120 may protrude into the space between the covering surface 111. Moreover, the connector receiving channel 120 may receive a connector 20 therein. Referring again to FIG. 1, it is important to note that the connector receiving channel 120 may allow a charging cord 21 to pass therethrough. As such, the connector 20 may be connected to the mobile device 10 through the connector receiving channel 120 while the mobile device 10 is connected to the main body 110.

Moreover, the connector receiving channel 120 may receive the connector 20 therein, such that the connector receiving channel 120 may at least partially cover the connector 20. Additionally, the connector receiving channel 120 may at least partially deform (i.e. bend, stretch) in response to receiving the connector 20 therein. In other words, the connector receiving channel 120 may be elastic to snugly fit the connector 20, such that the connector receiving channel 120 may prevent the connector 20 from detaching from the mobile device 10 while the main body 110 is connected to the mobile device 10 and the connector 20 is connected to the mobile device 10. Alternatively, the connector receiving channel 120 may be a fixed size corresponding to a size of the connector 20, such that a size of the connector receiving channel 120 may be based on the size of the connector 20. As such, the connector receiving channel 120 may have various sizes based on the size of the connector 20.

Furthermore, the adhesive may be disposed on an inner surface of the connector receiving channel 120 to resist movement of the connector 20 therein.

The plurality of grooves 130 may be disposed on at least a portion of the covering surface 111. More specifically, a first set of the plurality of grooves 130 may be disposed on at least a portion of a first side of the covering surface 111 and a second set of the plurality of grooves 130 may be disposed on at least a portion of a second side of the covering surface 111 opposite with respect to the first side. The plurality of grooves 130 may facilitate gripping thereof.

Therefore, the mobile device sleeve 100 may prevent the connector 20 from disconnecting from the mobile device 10, such that the mobile device 10 remains uncharged. Moreover, the mobile device sleeve 100 may facilitate holding and/or using the mobile device 10 while charging without worry of disconnecting.

The present general inventive concept may include a mobile device sleeve 100 removably connected to a mobile device 10, the mobile device sleeve 100 including a main body 110 to receive an end of the mobile device 10 therein, and a connector receiving channel 120 disposed on at least a portion of the main body 110 to receive a connector 20 of a charging cord 21 therein, such that the connector receiving channel 120 prevents the connector 20 from detaching from the mobile device 10 while the main body 110 is connected to the mobile device 10 and the connector 20 is connected to the mobile device 10.

The main body 110 may include a covering surface 111, and a base 112 disposed within at least a portion of an inner diameter of the covering surface 111 to prevent the mobile device 10 from passing entirely through a space between the covering surface 111.

The connector receiving channel 120 may at least partially deform in response to receiving the connector 20 therein.

The connector receiving channel 120 may include an adhesive disposed on an inner surface of the connector receiving channel 120 to resist movement of the connector 20 therein.

The mobile device sleeve 100 may further include a plurality of grooves 130 disposed on at least a portion of the main body 110 to facilitate gripping thereof.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A mobile device sleeve removably connected to a mobile device, the mobile device sleeve comprising:
a main body to receive an end of the mobile device therein; and
a connector receiving channel disposed on at least a portion of the main body to receive a connector of a charging cord therein, such that the connector receiving channel prevents the connector from detaching from the mobile device while the main body is connected to the mobile device and the connector is connected to the mobile device.

2. The mobile device sleeve of claim 1, wherein the main body comprises:
a covering surface; and
a base disposed within at least a portion of an inner diameter of the covering surface to prevent the mobile device from passing entirely through a space between the covering surface.

3. The mobile device sleeve of claim 1, wherein the connector receiving channel at least partially deforms in response to receiving the connector therein.

4. The mobile device sleeve of claim 1, wherein the connector receiving channel comprises:
an adhesive disposed on an inner surface of the connector receiving channel to resist movement of the connector therein.

5. The mobile device sleeve of claim 1, further comprising:
a plurality of grooves disposed on at least a portion of the main body to facilitate gripping thereof.
